(19) United States
(12) Patent Application Publication
(10) Pub. No.: US 2025/0030200 A1
(43) Pub. Date: Jan. 23, 2025

(54) ELECTRICAL CONNECTOR WITH IMPROVED SHIELDING PLATE DEFINING GROUNDING TERMINALS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: MING-CHING CHEN, New Taipei (TW)

(21) Appl. No.: 18/772,919

(22) Filed: Jul. 15, 2024

(30) Foreign Application Priority Data
Jul. 19, 2023 (CN) 202310884774.4

(51) Int. Cl. H01R 13/6581; H01R 12/71; H01R 13/502

(52) U.S. Cl. CPC H01R 13/6581; H01R 12/716; H01R 13/502

(57) ABSTRACT

An electrical connector includes: a housing extending along a longitudinal direction; two rows of conductive terminals retained in the housing, each row of conductive terminals comprising plural signal terminals and plural grounding terminals, each conductive terminal comprising a plate portion and a leg portion extending out of the housing, the plate portion defining an exposed outer face and an opposite inner face, the outer face defining a mating face; plural metal shielding plates being located inside the ground terminals in a transverse direction perpendicular to the longitudinal direction, the metal shielding plates being disposed between corresponding signal terminals of the two rows of conductive terminals in the transverse direction; and a metal connecting plate integrally connecting the plural grounding terminals and the plurality of metal shielding plates.

### BACKGROUND OF THE INVENTION

### 1. Field of the Invention

The present invention relates to an electrical connector with a metal connecting plate integrally connecting grounding terminals and metal shielding plates.

### 2. Description of Related Arts

Many electrical connectors include signal terminals and ground terminals in which the signal terminals convey data signals and the ground terminals reduce crosstalk and/or electromagnetic interference (EMI) between the signal terminals. In differential signaling applications, the signal terminals are arranged in signal pairs for carrying the data signals.

U.S. Pat. No. 9,509,098 discloses a connector including two rows of conductive terminals, and each row of conductive terminals includes signal terminals and ground terminals. The ground terminals in the two rows of conductive terminals are integrally connected to a ground tie bar to achieve common grounding. However, signal interference between the signal terminals of the two rows of conductive terminals will affect the transmission rate of the electrical connector, and the high-speed transmission electrical connector will generate serious heat, which may cause the plastic of the electrical connector to warp.

Therefore, an improved electrical connector is desired.

### SUMMARY OF THE INVENTION

An object of the present invention is to provide an electrical connector with an improved shielding plate.

In order to achieve above-mentioned object, an electrical connector comprises: a housing extending along a longitudinal direction; two rows of conductive terminals retained in the housing, each row of conductive terminals comprising plural signal terminals and plural grounding terminals, each conductive terminal comprising a plate portion and a leg portion extending out of the housing, the plate portion defining an outer face exposed upon the housing and an opposite inner face, the outer face defining a mating face; a plurality of metal shielding plates being located inside the ground terminals in a transverse direction perpendicular to the longitudinal direction, the metal shielding plates being disposed between corresponding signal terminals of the two rows of conductive terminals in the transverse direction; and a metal connecting plate integrally connecting the plural grounding terminals and the plurality of metal shielding plates.

Other objects, advantages and novel features of the present invention will become more apparent from the following detailed description of the present embodiment when taken in conjunction with the accompanying drawings.

### BRIEF DESCRIPTION OF THE DRAWING

FIG. 1 is a top perspective view of an electrical connector in accordance with the present invention;

FIG. 2 is a bottom perspective view of the electrical connector of FIG. 1;

FIG. 3 is an exploded perspective view of the electrical connector of FIG. 1;

FIG. 4 is another exploded perspective view of the electrical connector of FIG. 3 without the metallic shell;

FIG. 5 is a top perspective view of the electrical connector of FIG. 3 without the metallic shell, the housing block and the covering block;

FIG. 6 is an exploded perspective view of the electrical connector of FIG. 3 without the metallic shell and the housing block;

FIG. 7 is another exploded perspective view of the electrical connector of FIG. 6;

FIG. 8 is a cross-sectional view of the electrical connector taken along line 8-8 in FIG. 1; and

FIG. 9 is a cross-sectional view of the electrical connector taken along line 9-9 in FIG. 1.

### DETAILED DESCRIPTION OF THE PREFERRED EMBODIMENT

Reference will now be made to the drawing figures to describe the preferred embodiment of the present invention in detail.

An electrical connector 100 of an embodiment of this present invention installed on a circuit board (not shown) for transmitting high-speed signals.

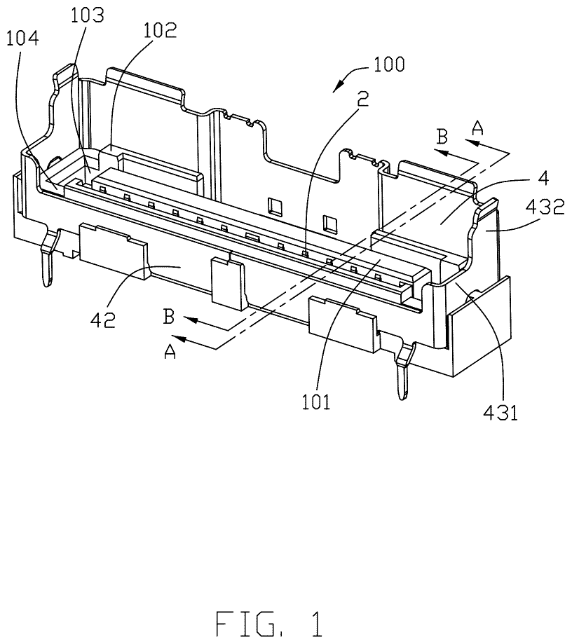

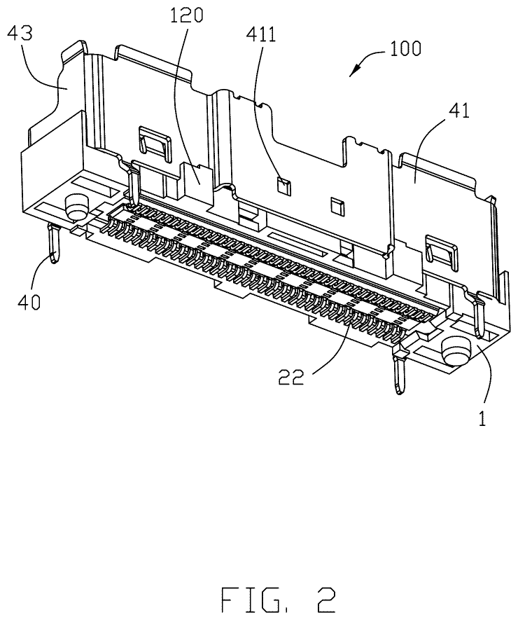

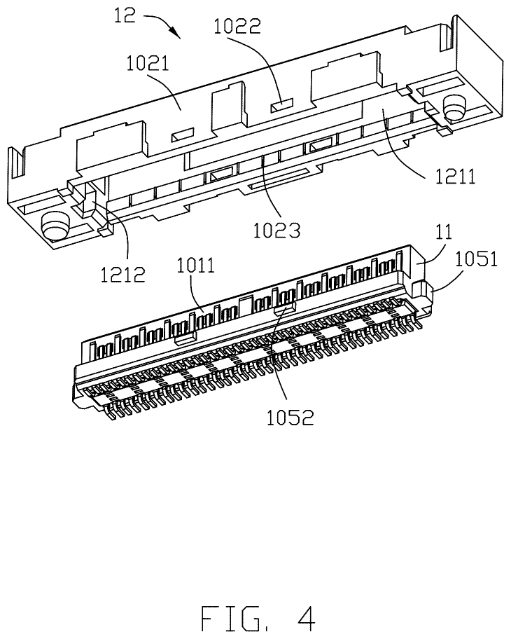

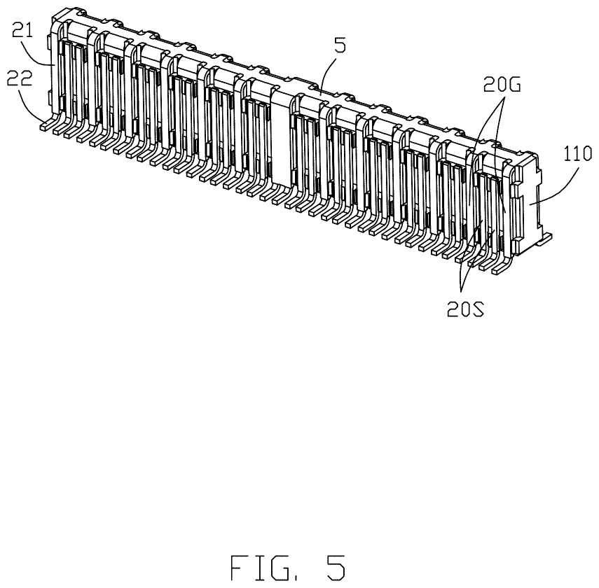

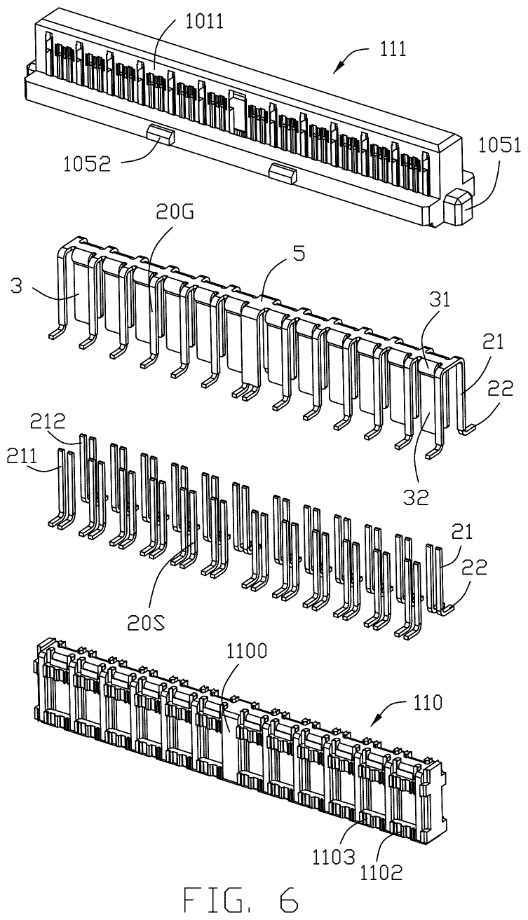

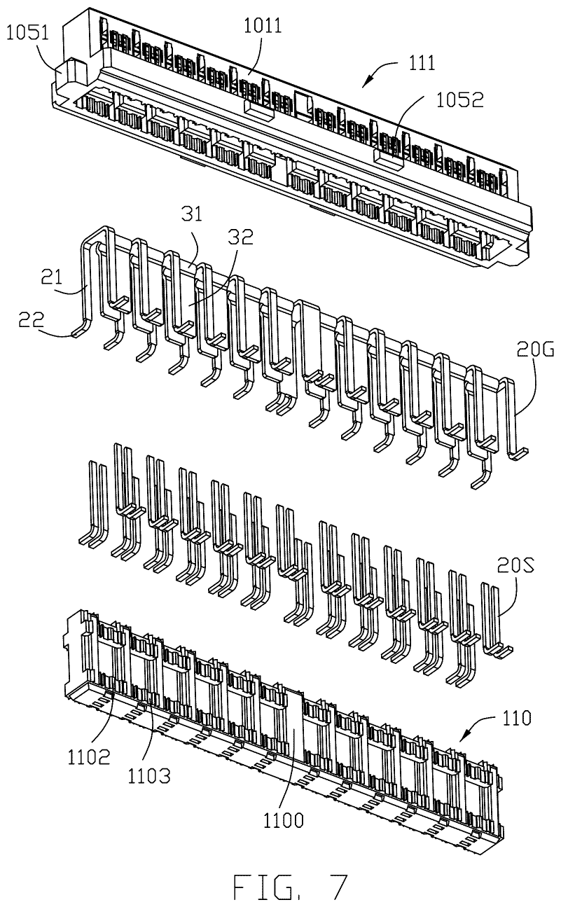

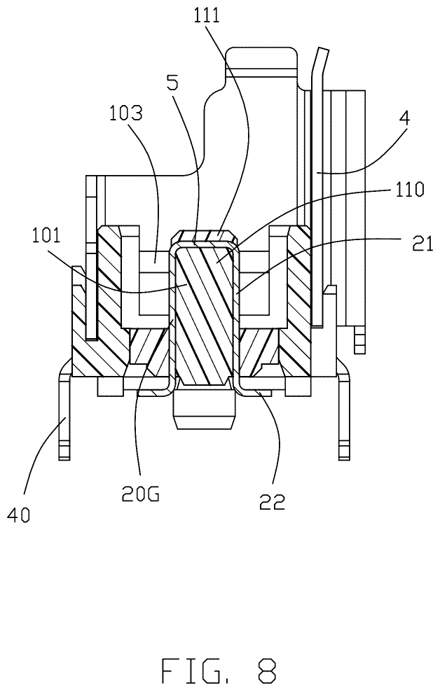

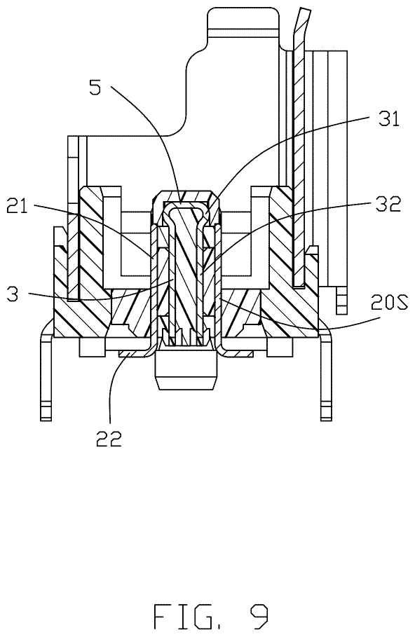

FIGS. 1-11 illustrate the electrical connector 100, the electrical connector 100 includes a housing 1 extending in a longitudinal direction, two rows of conductive terminals 2 made from a metal plate and retained in the housing 1, at least one metal shielding plate 3 disposed between the two rows of conductive terminals 2, and a metallic shell 4. The housing 1 includes a mating tongue 101 and a frame portion 102 surrounding the mating tongue 101, commonly defining a mating cavity 103 between the mating tongue 101 and the frame portion 102, the mating cavity 103 runs through a mating face 104 defined on the housing 1. The metallic shell 4 is attached an outside of the frame portion 102 and protrudes upward beyond the mating face 104. A first side plate 41 of the metallic shell 4 defines two locking holes 411, locking heads (not shown) of a locking arm (not shown) of a plug connector (not shown) protrude into the locking holes 411 from an outside of the first side plate 411, thereby obtaining a locking function of the two connectors. A second side plate 42 is substantial flushed with the mating face 104 and have a top edge lower than that of the first side plate 41. Two end plates 43 is of a step shape, each includes a first taller portion 431 and a second taller portion 432 extending beyond the mating face 104, the second taller portion 432 is substantial flushed with the first side plate 41 and higher than the first taller portion 431. Parts of the first taller portions 431 extend to the second side plate 42. A plurality of guiding tabs 44 extends upwards from the first side plate 41 and the second taller portion 432. Understandingly, the step portion of the metallic shell 4 provides an improved guiding performance during an engagement of the two connectors, and an improved enforced balance of two connectors. The housing 1 defines retaining portions 120 with slits, the metallic shell 4 seats in the slits for fitly retaining the metallic shell 4 on the housing 1. The lower ends of the first side plate 41 and the second side plate 42 extend downward to form soldering feet 40, and the soldering feet 40 are soldered to the circuit board (not shown).

The housing 1 includes a mating block 11 and housing block 12 assembled together, the mating block 11 includes the mating tongue 101 and a mounting portion 105 below the mating tongue 101, the housing block 12 includes a board portion 121 with a mounting opening 1211 and the frame portion 102. The mating block 11 is assembled through the mounting opening 1211 from a bottom end of the housing block 12, and the mounting portion 105 is fitly retained in the mounting opening 1211, thereby forming the housing 1. The mounting portion 105 defines two retaining lumps 1051 at opposite ends thereof, the board portion 121 defines recesses 1212 at a bottom face thereof. The retaining lumps 1051 are retained in the recesses 1212. Please notes, the recesses 1212 do not go upwards through the board portion 121, for limiting an upward movement of the mating block 11. The mounting portion 105 defines block portions 1052 at opposite sides thereof, two side walls 1021 of the frame portion 102 defines holding holes 1022 thereof. The block portions 1052 are received in the holding holes 1022. In addition, the inner wall surface of the side wall 1021 defines plural convex ribs 1023, and the convex ribs 1023 are used for interference fit with opposite sides of the mounting portion 105. In this embodiment, the two rows of conductive terminals 2 are retained in the mating block 11.

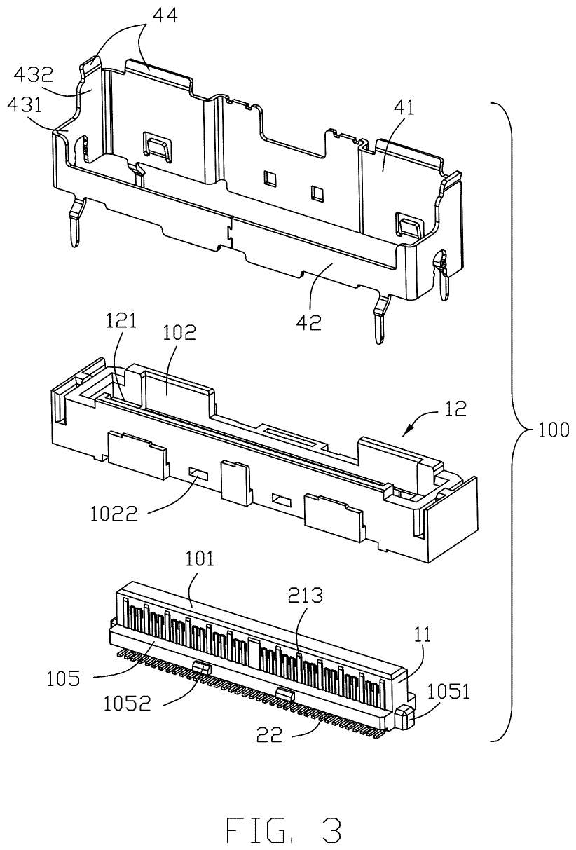

The conductive terminals 2 includes plate portions 21 and leg portions 22 extending from the plate portions 21 out of the housing 1, the plate portion 21 defines an inner face 212 and an outer face 211 exposed upon mating surfaces 1011 of the mating tongue 101 and functioned as a mating face or portion 213 as shown in FIG. 3. Each row of the conductive terminals 2 at least includes a signal terminal 20S and a grounding terminal 20G, in this embodiment two adjacent signal terminal 20S are construed as a pair of differential signal terminals, the grounding terminals 20G and the pairs of differential signal terminals alternate one by one. Each pair of differential signal terminals is sandwiched between two grounding terminals 20G at opposite sides thereof. The plate portions 21 of the grounding terminal 20G are longer than that of the signal terminals 20S and wider than that of the signal terminals.

In this embedment, the electrical connector 100 includes a metal connecting plate 5 extending in a longitudinal direction and the plural grounding terminals 20G and the metal shielding plate 3 are integrally extending from the metal connecting plate 5. In other words, plural grounding terminals 20G of two rows of the conductive terminals 2, the metal shielding plate 3, and the metal connecting plate 5 are formed by stamping and bending a same metal plate. In particular, the metal connecting plate 5 is a flat plate member extending in the longitudinal direction, the plural grounding terminals 20G of the two rows of conductive terminals 2 are bent downward from the transverse sides of the metal connecting plate 5, and the transverse sides of the metal connecting plate 5 are bent downward to form plural metal shielding plates 3 located inside the grounding terminals 20G. Each metal shielding plate 3 is located between the adjacent grounding terminals 20G in the longitudinal direction and the distance between the metal shielding plates 3 opposite in the transverse direction can be adaptively adjusted as needed. In other embodiments, the metal connecting plate 5 can also form the metal shielding plate 3 only on one transverse side, or the opposite transverse sides of the metal connector 5 are staggered in the longitudinal direction to form the metal shielding plate 3.

The mating block 11 includes a base block 110 and a covering block 111, the base block 110 is insert molded with the metal connecting plate 5, the grounding terminals 20G, and the metal shielding plate 3. Two opposite surfaces of the base block in the base block 110 in the transverse direction are provided with a plurality of protrusions 1102 arranged at intervals in the longitudinal direction, and retaining grooves 1103 are formed between the adjacent protrusions 1102. The signal terminals 20S in the two rows of conductive terminals 2 are fixed in the retaining grooves 1103, and the covering block 111 is insert molded with outside the base block 110 to hold the signal terminals 20S. The metal shielding plate 3 includes an arc-shaped portion 31 bent downward from the metal connecting plate 5 and a vertical plate portion 32 extending downward from the free end of the arc-shaped portion 31. The vertical plate portion 32 is located on the transverse inside of the arc-shaped portion 31. The arc-shaped portion 31 and the vertical plate portion 32 of the metal shielding plate 3 are both located inside of the grounding terminal 20G in the transverse direction.

A method of making the electrical connector 100 comprises: stamping and bending a metal plate to form the metal connecting plate 5, plural grounding terminals 20G and plural metal shielding plates 3; molding insulating material on the metal connecting plates 5, the metal shielding plates 3, and the metal shielding plates 3 to form the base block 110; providing plural signal terminals 20S and retain the signal terminals 20S into the retaining grooves 1103 of the base block 110; molding insulating material on the base block 110 to form the covering block 111; providing a housing block 12 with a mounting opening 1211 for assembling the mating block 11; providing a metal shell 4 surrounding the housing block 12 to form the electrical connector 100.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
a housing extending along a longitudinal direction;
two rows of conductive terminals retained in the housing, each row of conductive terminals comprising plural signal terminals and plural grounding terminals, each conductive terminal comprising a plate portion and a leg portion extending out of the housing, the plate portion defining an outer face exposed upon the housing and an opposite inner face, the outer face defining a mating face;
a plurality of metal shielding plates being located inside the ground terminals in a transverse direction perpendicular to the longitudinal direction, the metal shielding plates being disposed between corresponding signal terminals of the two rows of conductive terminals in the transverse direction; and
a metal connecting plate integrally connecting the plural grounding terminals and the plurality of metal shielding plates.

2. The electrical connector as claimed in claim 1, wherein the grounding terminals, the metal connecting plate, and the metal shielding plates are formed by stamping and bending a same metal plate, the metal connecting plate is a flat plate member extending in the longitudinal direction, the opposite sides of the metal connecting plate in the transverse direction are respectively integrally bent downward to form the grounding terminal, and at least one side of the metal connecting plate in the transverse direction is bent downward to form the metal shielding plates located between the signal terminals of the two rows of conductive terminals in the transverse direction.

3. The electrical connector as claimed in claim 2, wherein two adjacent signal terminals form a pair of differential signal terminals in each row of conductive terminals, the grounding terminals and the pairs of differential signal terminals alternate one by one, each pair of differential signal terminals is located between two grounding terminals at opposite sides thereof, the grounding terminals and the pairs of differential signal terminals in two rows of conductive terminals are aligned to each other in the transverse direction, the metal shielding plate is located between corresponding pairs of differential signal terminals in the two rows of conductive terminals in the transverse direction.

4. The electrical connector as claimed in claim 3, wherein the metal shielding plates extend downward from opposite sides of the metal connecting plate in the transverse direction between adjacent grounding terminals of the two rows of conductive terminals.

5. The electrical connector as claimed in claim 4, wherein corresponding metal shielding plates on opposite sides of the metal connecting plate in the transverse direction are spaced apart in the transverse direction.

6. The electrical connector as claimed in claim 2, wherein the metal shielding plates defines an arc-shaped portion bent downward from the metal connecting plate and a vertical plate portion extending downward from the arc-shaped portion, and the vertical plate portion is located on a transverse inner side of the arc-shaped portion.

7. The electrical connector as claimed in claim 2, wherein an upper end of the ground terminal is flush with an upper end of the metal shielding plate, and the upper end of the ground terminal extends upwards beyond an upper end of the signal terminal.

8. The electrical connector as claimed in claim 2, wherein the housing comprises a mating block having a mating tongue and a mounting portion and a housing block having a board portion with a mounting opening and a frame portion, the two rows of conductive terminals, the metal connecting plate, and the metal shielding plates are injection molded with the mating block, the mounting portion of the mating block is retained in the mounting opening and the mating tongue is surrounded by the frame portion to define a mating cavity between the mating tongue and the frame portion, and the mating faces of the conductive terminals are arranged along the mating tongue.

9. The electrical connector as claimed in claim 8, wherein the mating block defines a base block and a covering block, the base block are insert molded with the metal connecting plate, the grounding terminals, and the metal shielding plate, opposite surfaces of the base block in the transverse direction form a plurality of protrusions arranged in the longitudinal direction, and a positioning groove is formed between two adjacent protrusions in the longitudinal direction to fix corresponding signal terminals, and the covering block is insert molded with the base block.

10. The electrical connector as claimed in claim 8, further comprising a metallic shell, wherein the metallic shell surrounds the housing and extends upwards beyond a mating face of the housing, the metallic shell comprises a first side plate, a second side plate, and two end plates connecting with the first side plate and the second side plate, and the first side plate defines a locking hole.
